(19) United States
(12) Patent Application Publication
(10) Pub. No.: US 2006/0226974 A1
(43) Pub. Date: Oct. 12, 2006

(54) Method and device for monitoring persons needing care

(76) Inventor: Gunter Fluegel, Potsdam (DE)

Correspondence Address: KENYON & KENYON LLP, ONE BROADWAY, NEW YORK, NY, 10004, US

(21) Appl. No.: 11/350,702

(22) Filed: Feb. 8, 2006

(30) Foreign Application Priority Data
Feb. 8, 2005 (DE) 10 2005 006 037.4

(51) Int. Cl. G08B 1/08

(52) U.S. Cl. 340/539.12; 340/573.1; 340/539.13

(57) ABSTRACT

A method and device for monitoring persons in need of constant care, such as mentally confused people in homes for assisted living. Such persons are furnished with a device to be worn by them that cannot be removed or deactivated independently, which, in the event the person leaves the care area, automatically alerts a place qualified to provide help. The departure from the care area is detected by a location-detection unit of the worn device. In the event of departure from the care area, the vital values of the person are determined and, depending on the vital values determined, a connection is set up via a mobile telephone network to one of several places qualified to help. Information concerning the vital values and the whereabouts of the affected person is transmitted to this place.

### FIELD OF INVENTION

The present invention relates to a method and device for monitoring persons in need of constant care.

### BACKGROUND INFORMATION

Mentally confused people, e.g., older people having symptoms of dementia, require constant care or at least housing where they can receive immediate care in case of need. These people are often accommodated in special nursing homes or in facilities for assisted living. However, it happens again and again that these people leave the safe area set up for their care unintentionally, or, on their own initiative, because of their mental confusion. In so doing, however, they expose themselves to great danger, since leaving the tended area is often associated with great health risks for them, and for the most part, they are helpless outside of this area or very quickly lose their orientation. And, because the personnel situation at suitable facilities is often overstretched, continuous personal monitoring of these people, possibly backed up by video-engineering devices, is not always possible. Thus, tragic cases have been reported in which persons have left a nursing home unnoticed and, because of existing health problems and the lack of possibilities for discovering they have run away or for finding them again, have died.

The so-called electronic ankle bracelet is available for monitoring offenders who, instead of imprisonment, are placed under house arrest. For this, the person to be monitored is furnished with a band, e.g., to be worn on the leg, which the offender cannot remove by him/herself. Fastened to this band is a transmitter which communicates with an associated receiver on the telephone located in the home of the person to be monitored. Signals are emitted cyclically by the transmitter on the ankle bracelet. Based on the transmission signals received or not received from the associated transmitter, it is possible to determine in what periods of time the offender is in his home and when not. In view of the resocialization striven for, and therefore, the possibility explicitly desired that the monitored person pursue employment, data which indicate when the offender must be in his home according to his sentence are stored in an electronic device coupled to the receiver and to the telephone of the offender. If the offender is out of his home beyond permissible tolerance limits, the electronic device ultimately sets up a telephone connection to a police station or a prison authority and a message about the absence of the monitored person is output via the telephone connection. However, this form of electronic ankle bracelet is not usable for the purpose indicated at the outset. For example, when the offender leaves his home for the purpose of pursuing a regulated activity, which is desired, the wearing of the electronic ankle bracelet does not lead to the triggering of an alarm. In addition, in the event the offender leaves unlawfully, the electronic ankle bracelet constructed in the manner described does not make it possible to determine his whereabouts. The technical functioning method of the electronic ankle bracelet is explained, for example, at www.hmdj.justiz.hessen.de.

Furthermore, at the Internet address www.kretschmer-berlin.com/notte14.htm, solutions are described by which persons can be monitored with regard to their specific whereabouts. However, these devices are not suitable or not adequate for solving the problem addressed herein.

### DETAILED DESCRIPTION

Embodiments of the present invention relate to a method and device for monitoring persons in need of constant care, to ensure that, to the greatest extent possible, such persons, especially mentally confused people who are accommodated in homes for assisted living and need constant care, do not leave the protected area set up for their care unnoticed, and, if they do leave, can be brought quickly again to suitable care.

Embodiments of the present invention provide a reliable method and device for determining the “escape” of persons needing care from a protected area and to initiate measures for their return. In the present invention, it is made possible to immediately initiate the return measure which is best in each instance, depending on the physical condition of the person in question.

Embodiments of the present invention provide a method for monitoring persons who are in need of permanent care, in which a person needing care is furnished with a device to be worn on the body which cannot be removed or deactivated independently by the person, and which signals a departure of the person in question from an area set up for his/her care, to a place qualified to provide help for the person. In the event the person needing care leaves the care area, the whereabouts and vital values of this person are determined by units of the device carried by the person which are designed for this purpose. And, depending on the vital values determined, a connection is set up via a mobile telephone network to one of several phone numbers, stored in the device, of places qualified to help, and information concerning the vital values determined and concerning the whereabouts of the affected person is transmitted via this connection. Thus, depending on the condition of the person, the place informed about the situation brings about a return of the person to the safe area or/and his medical care.

Embodiments of the present invention provide a device for implementing the method designed, for example, as a band to be worn on an arm or a leg of a person needing care which he/she cannot remove independently, having electronic units undetachably disposed thereon which signal a departure of the person in question from an area set up for his/her care, to a place qualified to provide help for the person. The exemplary device includes a control unit having a memory, a unit for detecting location, means for measuring and evaluating the blood pressure and/or the pulse rate, means for configuring the device, and a mobile telephone unit by which, induced by the control unit, in the event the person needing care leaves the care area and/or the blood pressure or the pulse rate exceeds a limit value stored in the memory of the device, a connection is set up, depending on the event detected, to one of several phone numbers, stored in the device memory, of places qualified to help, and information concerning the vital values detected and concerning the whereabouts of the person affected is transmitted via this connection.

In further embodiments, the vital values and the whereabouts of the person in question may be recorded repeatedly and transmitted repeatedly to the place providing help and intended for their reception, depending on the vital values determined.

In further embodiments, the vital values are also recorded cyclically, independently of a possible departure of the person needing care from the care area, and if a limiting value, stored in the device carried by the person, for at least one of the monitored vital values is exceeded, a place qualified to provide medical care for the person is alerted via an automatically set-up mobile telephone connection.

In further embodiments, in the case of an alert, the data concerning the vital values and the whereabouts of an affected person are transmitted in the form of an SMS, MMS or E-mail to the place intended for their reception.

In further embodiments, the data concerning the vital values and/or the whereabouts of an affected person are displayed graphically at the place being alerted.

In further embodiments, a person needing constant care wears a device on his/her body. The device is made such that it cannot be removed and/or deactivated independently by the person wearing the device. The device is configured so that it automatically alerts a place qualified to aid the person in the event the person leaves an area set up for his care. In this context, the departure of the person in question from the care area is detected, for example, by a location-detection unit which is a component of the device worn by the person. If the location-detection unit determines that the person is leaving the care area, the vital values of the person are determined by means configured for that purpose in the device carried by the ward. And, depending on the vital values determined, a connection may be set up via a mobile telephone network to one of several places stored in the device that are qualified to provide help. Information concerning the vital values and the current whereabouts of the person in question is transmitted via this connection. The place to be alerted is selected as a function of the vital values determined for the person in question, and the place is informed immediately about the person's current whereabouts. If necessary, an emergency medical practitioner may also thereby be brought immediately and quickly to the person in question, if indicated by the vital values. Thus, this can serve to eliminate the need for extensive costs for search measures by the personnel of a nursing home or by the police. The danger of fatalities, as unfortunately was more often the complaint in the past, can also markedly be reduced using the present invention. In addition to improving the safety of the persons affected, the embodiments of the present invention can have a positive effect in relieving some emotional strain of the attending personnel.

In further embodiments, the vital values and the whereabouts of the person in question are recorded repeatedly and transmitted to the place intended for their reception depending on the vital values determined. This is based on the consideration that, although the fact that a person (or ward of the place) is leaving or running away from the care area is detectable very rapidly using the method in its basic form, it has been seen in the past that in such a case, mentally confused people can develop an astonishing speed by which they increasingly quickly leave the care area. However, the initiation of measures for returning such persons always requires a certain time. Therefore, as part of the procedure described above, the data relating to the whereabouts and the vital values of the person to be brought back are updated cyclically.

In further embodiments, the vital values are determined cyclically, regardless of whether a monitored person is in the care area or has left it. In the event that at least one of those vital values exceeds a predefined limit, a place qualified to provide medical help is alerted. In a further embodiment, in the event of an alert, data concerning the vital values and the whereabouts of an affected person are transmitted in the form of, e.g., an SMS (short message service), MMS (Microsoft media server), or E-mail. In a further embodiment, the relevant data are visualized in graphic form at the respective place being alerted.

In further embodiments, the device is a band to be worn on the arm or leg of the person to be monitored. Disposed on the band are electronic units for recording and evaluating the blood pressure and/or the pulse rate of a person wearing the device, a location-detection unit, e.g., a GPS receiver, and a mobile telephone unit, e.g., a GSM unit, for setting up the connection and for transmitting the data to the place to be alerted in each instance. In further embodiments, such units are integrated in one common housing undetachably joined to the band. The device is made such that it is not removable or deactivated independently. In further embodiments, the device includes a control unit having a memory for controlling the above-described units (e.g., mobile telephone unit, location-detection unit, etc.), and for storing configuration data and different phone numbers. Depending on the event detected (e.g., person has left the care area, but vital values are normal or at least one vital value has exceeded a limit), the control unit causes one of the phone numbers stored in the memory to be selected for setting up the connection and for transmitting data, and induces the mobile telephone unit to set up the connections and to transmit the vital values and data concerning the current whereabouts of the person. In further embodiments, the device includes means for its configuration. The means may either be operating elements on the device itself, or a data interface for transmitting suitable configuration data into the memory of the device. The use of, e.g., a data interface, can assist with regard to security against manipulation. In any case, the means for its configuration, e.g., operating elements on the device, data interface, should be configured to at least ensure that the settings of the device cannot be altered by the person requiring care.

For example, suppose a person, wearing the device of the present invention, leaves the area provided for his/her care. This departure is detected with the aid of the GPS receiver by a comparison of the specific instantaneous GPS coordinates to data that are stored in the device of the present invention and that image the care area. The means for recording vital values, namely, the blood pressure and the pulse rate of the monitored person, are activated now at the latest. A connection to a phone number stored in the memory of the device is set up by the GSM unit of the device, the phone number being selected from several phone numbers stored in the memory depending on the instantaneous vital values detected.

For example, a phone number of the personnel of a home normally housing the person, a phone number of the doctor or the nursing service treating the person there, as well as an emergency physician number are stored in the device memory. In a further example, if the person who has left the care area is in a very critical condition, a connection is set up to the emergency physician, and upon existence of this connection, the instantaneous values for blood pressure and pulse rate are transmitted to the opposite terminal. For example, this may be accomplished by an automatically dispatched SMS of the form, e.g., “Person A has left, is at location X,Y. Blood pressure: . . . , pulse rate: . . . ”. The personnel of the emergency-number practice are immediately able to take measures which make it possible to medically care for the person affected. Further, the home personnel and/or the house doctor or the nursing service of the home may be additionally alerted. And, the home personnel and/or house doctor or nursing service also may be informed that the emergency physician was already alerted by the device.

If, at the moment the person leaves the care area, his/her vital values are normal or within acceptable limits, it may be sufficient to notify the home personnel or the personnel dealing with the customary care. A suitable SMS could then have the form, e.g., “Person A has left, is at location X, Y. The vital values are normal.” In this case, depending on convenience and taking into consideration the length limitation of an SMS, the information concerning the current whereabouts of the person may be specified by street designations, or merely transmitted as GPS coordinates. In the case of a communication by E-mail, detailed information concerning the whereabouts may also be transmitted, even including a map section.

What is claimed is:

1. A method for monitoring a living entity in need of care, comprising:
providing the living entity with a device wearable by the living entity, the device being at least one of unremovable by the living entity and undeactivatable independently by the living entity;
signaling an assistance entity when the device notes a departure of the living entity from a predesignated area;
determining, using at least one unit disposed on the device, at least one of a location and a vital value of the living entity, when the device notes the departure;
comparing the vital value with a predetermined limit value;
contacting via a mobile telephone network at least one telephone number stored in the device and associated with a respective predesignated assistance location depending upon the comparing of the vital value with the predetermined limit value,
wherein any assistance location contacted also receives information concerning the location and the vital value of the living entity so that the living entity can be found and treated appropriately.

2. The method as recited in claim 1, further comprising:
recording repeatedly the at least one of the location and the vital value of the living entity; and
transmitting repeatedly the at least one of the location and the vital value of the living entity to the respective predesignated assistance location,
wherein the respective predesignated assistance location is determined based on the vital value of the living entity.

3. The method as recited in claim 1, further comprising:
recording the vital value cyclically; and
alerting the appropriate assistance location via an automatically set-up mobile telephone connection if at least one of the vital values recorded exceeds a respective predetermined limit value, the predetermined limit value being stored by the device,
wherein the appropriate assistance location is a qualified medical care location.

4. The method as recited in claim 1, further comprising:
transmitting the vital value and the location of the living entity to the appropriate assistance location as at least one of a short message service, multimedia service, and email.

5. The method as recited in claim 1, further comprising:
displaying graphically at the appropriate assistance location data concerning at least one of the vital values and the location of the living entity.

6. A device for a person needing care, comprising: a wearable piece to be worn on a person needing care which he/she cannot remove independently, having electronic units undetachably disposed thereon which signal a departure of the person in question from an area set up for his/her care, to a place qualified to provide help for the person, wherein the device includes a control unit having a memory, a unit for detecting location, means for measuring and evaluating the blood pressure and/or the pulse rate, means for configuring the device, as well as a mobile telephone unit by which, induced by the control unit, in the event the person needing care leaves the care area and/or the blood pressure or the pulse rate exceeds a limit value stored in the memory of the device, a connection is set up, depending on the event detected, to one of several phone numbers, stored in the device memory, of places qualified to help, and information concerning the vital values detected and concerning the whereabouts of the person affected is transmitted via this connection.

7. The device of claim 6, wherein the wearable piece is a band which attaches to an arm or a leg of the person.
